(19) United States
(12) Patent Application Publication
(10) Pub. No.: US 2006/0175967 A1
(43) Pub. Date: Aug. 10, 2006

(54) Animated miniature electroluminescent billboards with hidden conductors

(75) Inventor: Christopher Miller, Stamford, CT (US)

Correspondence Address: Lipsitz & McAllister, LLC, 755 MAIN STREET, MONROE, CT, 06468, US

(73) Assignee: Miller Engineering LLC, Stamford, CT (US)

(21) Appl. No.: 11/053,699

(22) Filed: Feb. 7, 2005

(51) Int. Cl. H01J 1/62; H01J 63/04

(52) U.S. Cl. 313/510

(57) ABSTRACT

The present invention provides improvements to electroluminescent devices particularly useful for illuminated signs and billboards designed for use with model railroads. Electroluminescent devices disclosed in the present application provide a simulation of a billboard by raising the illuminated portion of the billboard above the location of the electrical connection. The illuminated portion appears to be appropriately separated from the electrical connection with a transparent portion. Electrical conductors pass through the transparent portion to couple to the electroluminescent electrodes without ruining the aesthetics of the final product. The electrical conductors pass through the transparent portion in such a way as to simulate struts that support the illuminated portion.

### BACKGROUND OF THE INVENTION

The present invention relates generally to the application of electroluminescence technology to consumer electronic devices, such as model railroad accessories. In particular, the present invention provides apparatus and methods for simulating illuminated structures that are typically raised above the ground, such as billboards.

Scale model scenes include several types of structures and features, such as railroads, buildings, figurines and illuminated structures. Illuminated structures may include street lights, traffic lights, building signs, roadside signs and billboards. Several lighting techniques including electroluminescence and liquid element displays (LED) may be utilized to provide illumination. Illumination techniques for scale model scenes often include animation to enhance the visual experience with motion.

Electroluminescence (EL) technology has been known for several decades. EL technology provides a bright light source with low power consumption and limited heat production. The principal of operation includes supplying an AC circuit through a phosphor compound.

When electrical power is applied against the phosphorous, an electron is excited to a higher valence state. As the amplitude of the current decreases, the electron returns to a relaxed state and emits a photon of light in the visible region. The wavelength of light, and therefore the color, can be modified by choosing the appropriate phosphor compound or using a film cover. The brightness of the light can be regulated by the frequency or amplitude of the current.

The construction of an EL device consists of a sandwich structure containing a substrate, a rear electrode, an insulating layer, the phosphor layer, a transparent front electrode, and a protective layer. Alternative structures allow the light to be emitted from both the front and back of the EL device. Additional structures can be used to provide illuminated wire. EL devices currently find application as lamps, signs, animated billboards and toys. However, the electrical supply requirements limit the ability to provide signs with completely transparent sections.

Specifically, providing multiple lighting patterns to the luminescent structure presents a problem for the typical electroluminescent device because the conductors are visible and disturb the coherent design of the device.

It would be advantageous to provide EL devices that contain a transparent area, without letting the electrical supply conductors, which pass therethrough, ruin the aesthetics of the final product. It would be further advantageous to provide miniature EL billboards or the like, e.g., for use in model railroads, with means for hiding the electrical conductors that couple to the EL electrodes. The present invention provides EL devices and methods having these and other advantages.

### SUMMARY OF THE INVENTION

The present invention provides improvements to electroluminescent devices. In particular, the present invention is particularly useful for illuminated signs and billboards designed for use with model railroads. In one embodiment, the electroluminescent devices disclosed in the present application provide a simulation of a billboard by raising the illuminated portion of the billboard above the location of the electrical connection, while the illuminated portion appears to be appropriately separated from the ground with a transparent portion.

Accordingly, one embodiment of the invention is directed to an electroluminescent device that simulates a billboard composed of a substrate including a transparent portion, a portion bearing luminescent indicia, and a connector portion. The transparent portion is constructed with simulated struts that appear to support the luminescent indicia portion. The transparent portion also includes electrical conductors running in registration with some of the struts in such a way that the electrical conductors are hidden from view on at least one face.

The embodiment shown is oriented so that the luminescent indicia appears to be supported from below; however, the same technique may be applied to indicia supported from the sides, as in building signs or highway signs, or indicia supported from above, such as stadium scoreboards. The connector portion of the embodiment is located opposite to the luminescent indicia with respect to the transparent portion. The conductors transfer high voltage AC power from the connectors to the luminescent portion.

The struts of the present embodiment are constructed of silk screened ink, paint or dye printed upon a substrate of substantially transparent mylar. The mylar may be substituted by any transparent, non-conductive material. The luminescent indicia are constructed of a transparent substrate, a transparent conductive coating layer, a silk screened phosphor layer, an insulating layer, an opaque conductive coating layer and a silk screened ink, paint or dye layer. Other methods of constructing electroluminescent indicia are well known in the art and may alternatively be practiced.

The present invention further provides a method for constructing an electroluminescent device that simulates a billboard. The process of construction includes applying at least one luminescent segment representative of indicia on a substrate. Conductors are applied to said substrate for coupling electrical signals to the at least one luminescent segment. The conductors traverse a transparent portion of the device. Simulated struts are applied over the conductors to hide the conductors from view on at least one face of the substrate. The simulated struts appear to be supporting the indicia from a particular direction, such as below the indicia.

In the present method, a connector segment is attached to the conductors. The simulated struts are composed of silk screened ink, paint or dye printed on a mylar substrate. The luminescent layer is composed of a mylar layer, a transparent conductive coating layer, a silk screened phosphor layer, an insulating layer, an opaque conductive coating layer, and a silk screened ink, paint or dye layer.

### BRIEF DESCRIPTION OF THE DRAWINGS

FIG. 1 is a front view of an electroluminescent display according to the invention.

FIG. 2 is a view of the rear of an electroluminescent display according to the invention.

FIG. 3 is a cross-sectional view of the luminescent portion an electroluminescent display according to the invention.

FIG. 4 is a cross-sectional view of the transparent portion an electroluminescent display according to the invention.

FIG. 5 is a cross-sectional view of a strut for an electroluminescent display according to the invention.

FIG. 6 is a schematic diagram of an electroluminescent display according to the invention.

### DETAILED DESCRIPTION

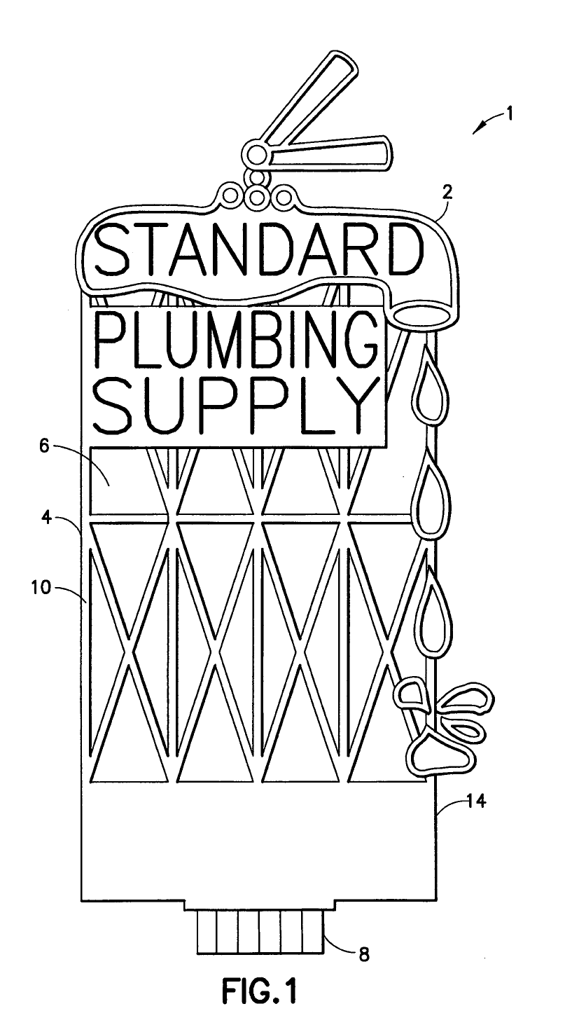

FIG. 1 illustrates a front view of an electroluminescent display generally designated 1 as might be used in a model railroad application. The display includes a luminescent portion 2, a transparent portion 4, and a connector 8. The luminescent portion produces illumination in the form of electroluminescence. The transparent portion includes segments of transparent substrate 6 separated by opaque struts 10. The transparent substrate 6 may be any transparent, non-conductive material, such as mylar. Electrical conductors 12 run in registration with the struts 10 in such a way that the electrical conductors 12 are not visible from the front view. The connector 8 is connected to an opaque portion 14.

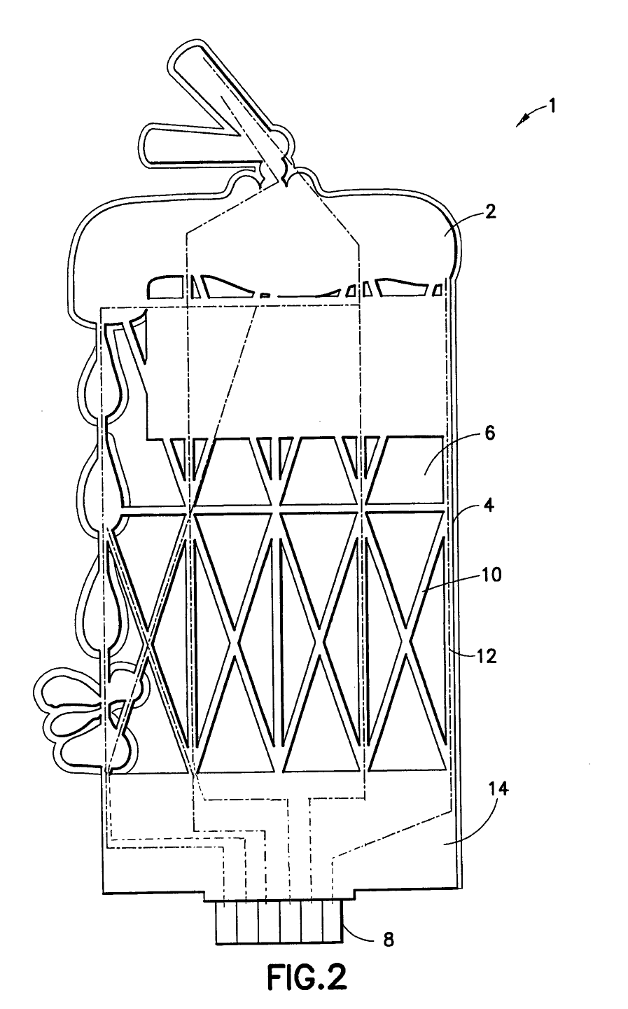

FIG. 2 illustrates the rear view of an electroluminescent display 1 as might be used in a model railroad application. The rear view demonstrates how the conductors 12 (broken lines) may be placed on the display so that they are effectively hidden from view in the front view while providing a transparent portion 4 between the connector 8 and the luminescent portion 2. As illustrated, the electrical conductors 12 communicate with the connectors via an opaque portion 14 wherein the electrical conductors 12 are directed to locations aligning with the struts 10. The conductors 12 run in registration with the struts 10 to the luminescent portion 2.

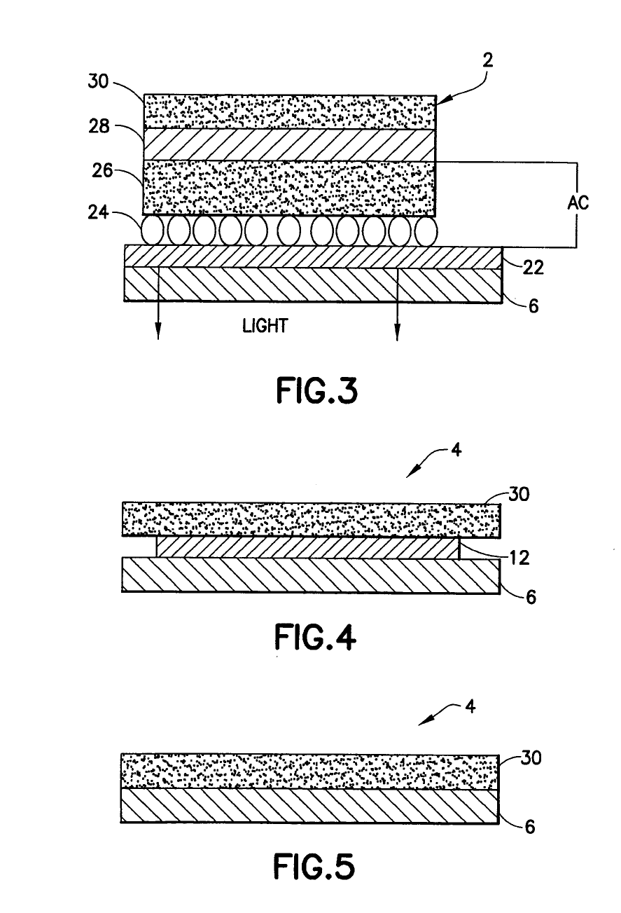

FIG. 3 shows a cross-section illustrating layers of the luminescent portion 2. The construction of the luminescent portion 2 consists of printing layers upon a transparent substrate 6 which can, for example, comprise mylar. The process of producing a luminescent portion is well known in the art. Upon the transparent substrate 6, a transparent conductive coating 22 (e.g., tridium tin oxide), a silk screened phosphor layer 24, an insulating layer 26 (e.g., barium titanate), and a conductive coating 28 (e.g., silver) are provided. These layers can be coated with a silk screened ink, paint or dye layer 30.

FIG. 4 shows a cross-section illustrating layers of the transparent portion 4 wherein the electrical conductors 12 run. Similar to FIG. 3, multiple layers are printed upon a transparent substrate 6, e.g., mylar. The electrical conductors 12 are hidden with a silk screened ink, paint or dye layer 30 provided on the transparent substrate 6. In accordance with the invention, the ink, paint or dye is formed in the shape of struts. The electrical conductors 12 are constructed in such a way as to be camouflaged from the front view by the struts 10. More particularly, the electrical conductors are run across the transparent area in a pattern that simulates struts. The conductors are then covered by the ink, paint, or dye which is preferably in a dark color (e.g., black) to enhance the strut-like appearance.

FIG. 5 shows a cross-section illustrating layers of the transparent portion 4 wherein the struts 10 run without an underlying electrical conductor. The struts 10 consist of a silk screened ink, paint or dye layer 30 printed on a mylar substrate layer 20. Not shown in a separate figure are the portions of the transparent substrate 6 which consist solely of a transparent substrate, such as mylar.

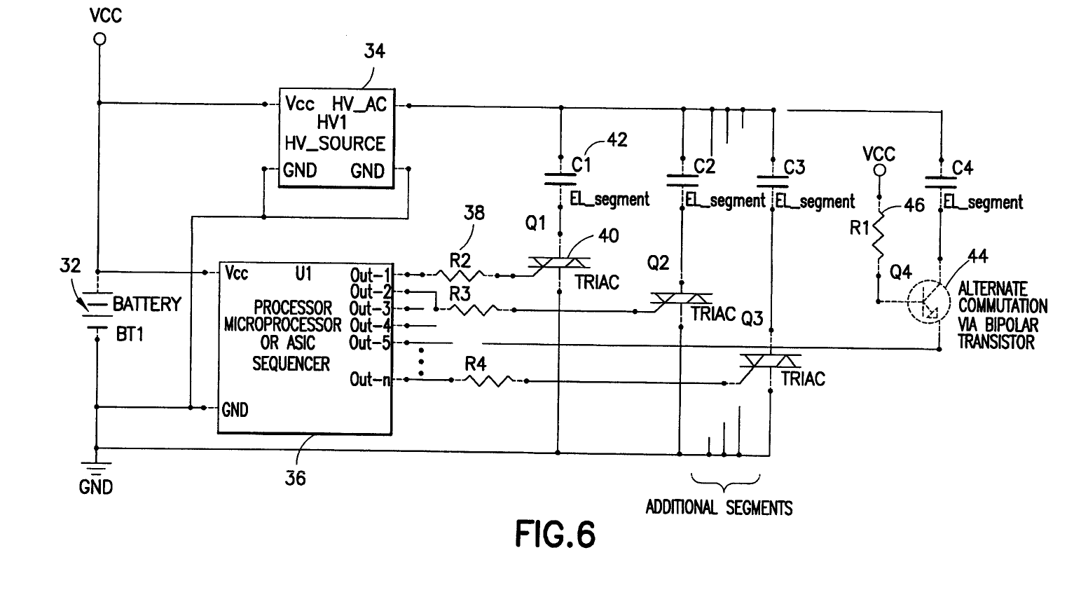

FIG. 6 is a schematic diagram of an electroluminescent display according to the invention. The power sequence demonstrated is well known in the art. A direct current (DC) battery 32 supplies power to a high voltage (HV) alternating current (AC) converter 34. The HV AC converter 34 converts the DC signal to AC in the range of 80 to 250 Volts RMS at a frequency of 100 Hz to 1000 Hz. DC power is also supplied to a microprocessor or ASIC chip controller 36 that sends timed, preprogrammed signals to turn on one of several TRIACs 40. A resistor 38 is interposed between the controller 36 and the TRIAC 40 to limit the current supplied to each electroluminescent segment 42. The TRIAC 40 commutes the HV AC to specific electroluminescent segments 42 of the electroluminescent display 1 causing them to luminesce at particular intervals. This process allows the various electroluminescent segments 42 to luminesce at different intervals and sequences. Additional electroluminescent segments 42 can be directly connected between the DC source 32 and the HV AC converter 34 to provide continuous luminescence.

As an alternative to the TRIAC 40, a high voltage bipolar transistor 44 can be used to commute the HV AC. Because bipolar transistors normally conduct in only one direction, the reverse current path can be provided through the battery 32, transistor base current limiting resistor 46, and through the normally reverse biased base-to-collector junction of the bipolar transistor 44.

It should now be appreciated that the present invention provides advantageous methods and EL devices containing a transparent area, without letting the electrical supply conductors, which pass therethrough, ruin the aesthetics of the final product. The EL devices may be utilized as miniature EL billboards or the like, e.g., for use in model railroads, with means for hiding the electrical conductors that couple to the EL electrodes. The electrical conductors may be hidden in the transparent area by passing through the transparent area in such a way that they appear to be struts supporting the luminescent indicia.

Although the invention has been described in connection with various illustrated embodiments, numerous modifications and adaptations may be made thereto without departing from the spirit and scope of the invention as set forth in the claims.

What is claimed is:

1. An electroluminescent device comprising:
a substrate having a transparent portion and a portion bearing luminescent indicia, said transparent portion bearing simulated struts that appear to be supporting said indicia from a direction; and
electrical conductors running in registration with at least some of said struts, said struts hiding said electrical conductors from view on at least one face of said substrate.

2. An electroluminescent device as in claim 1 wherein said luminescent indicia and said struts together simulate a billboard.

3. An electroluminescent device as in claim 1 wherein said direction is below said indicia.

4. An electroluminescent device as in claim 1 wherein said direction is above said indicia.

5. An electroluminescent device as in claim 1 wherein said direction is to the right of said indicia.

6. An electroluminescent device as in claim 1 wherein said direction is to the left of said indicia.

7. An electroluminescent device as in claim 1 comprising a connector disposed opposite said indicia with respect to the transparent portion wherein said conductors couple said connector to said luminescent indicia.

8. An electroluminescent device as in claim 1 wherein said struts comprise a silk screened ink, paint or dye layer printed on said substrate.

9. An electroluminescent device as in claim 1 wherein said luminescent indicia comprises:
a transparent conductive coating layer;
a silk screened phosphor layer;
an insulating layer;
an opaque conductive coating layer; and
a silk screened ink, paint or dye layer;
printed on said substrate.

10. A method of fabricating an electroluminescent device, comprising:
applying at least one luminescent segment representative of indicia on a substrate;
applying conductors to said substrate for coupling electrical signals to said at least one luminescent segment, said conductors traversing a transparent portion of said substrate;
applying simulated struts over said conductors to hide said conductors from view on at least one face of said substrate;
wherein said simulated struts appear to be supporting said indicia from a direction.

11. A method of fabricating an electroluminescent device as in claim 10, wherein said indicia and said struts together simulate a billboard.

12. A method of fabricating an electroluminescent device as in claim 10, comprising attaching a connector segment to said on a side of said transparent portion which is opposite said indicia.

13. A method of fabricating an electroluminescent device as in claim 10, wherein said simulated struts comprise a silk screened ink, paint or dye printed on said substrate.

14. A method of fabricating an electroluminescent device as in claim 10, wherein said at least one luminescent segment comprises:
a transparent conductive coating layer;
a silk screened phosphor layer;
an insulating layer;
an opaque conductive coating layer; and
a silk screened ink, paint or dye layer;
printed on said substrate.
